(19) United States
(12) Patent Application Publication
(10) Pub. No.: US 2022/0316892 A1
(43) Pub. Date: Oct. 6, 2022

(54) CONTROL APPARATUS, SYSTEM, VEHICLE, AND CONTROL METHOD

(71) Applicant: TOYOTA JIDOSHA KABUSHIKI KAISHA, Toyota-shi (JP)

(72) Inventors: Kodai TAKANOHASHI, Okazaki-shi (JP); Atsushi OKUBO, Nisshin-shi (JP); Yuji TACHIBANA, Nisshin-shi (JP); Shogo MOMOSHIMA, Nagoya-shi (JP); Takaaki KATO, Saitama-shi (JP); Daiki KANEICHI, Tokyo (JP); Minoru NAKADORI, Toyota-shi (JP)

(21) Appl. No.: 17/649,908

(22) Filed: Feb. 3, 2022

(30) Foreign Application Priority Data
Mar. 31, 2021 (JP) 2021-061890

(51) Int. Cl. G01C 21/34

(52) U.S. Cl. CPC G01C 21/3461

(57) ABSTRACT

A control apparatus includes a control unit configured to execute control for presenting, in a vehicle, a first route along which a vehicle moves to a parking space in a parking lot, predict a second route along which a pedestrian moves in the parking lot, and execute control for presenting, in the vehicle, a third route that replaces the first route when the first route intersects the second route.

### CROSS-REFERENCE TO RELATED APPLICATION

This application claims priority to Japanese Patent Application No. 2021-061890 filed on Mar. 31, 2021, incorporated herein by reference in its entirety.

### BACKGROUND

### 1. Technical Field

The present disclosure relates to a control apparatus, a system, a vehicle, and a control method.

### 2. Description of Related Art

Japanese Unexamined Patent Application Publication No. 2019-091279 discloses an apparatus that sets a movement route such that a vehicle moves in an area in a parking lot in which there is a relatively low risk that a pedestrian will suddenly appear.

### SUMMARY

The setting of the movement route to the vehicle by the above apparatus is not based on a route along which the pedestrian actually moves. For this reason, there is a probability that the vehicle may stop to wait for the pedestrian to cross a road and cannot smoothly move in the parking lot.

The present disclosure provides a control apparatus, a system, a vehicle, and a control method that enables a vehicle to smoothly move in a parking lot.

A control apparatus according to a first aspect of the present disclosure includes a control unit. The control unit is configured to execute control for presenting, in a vehicle, a first route along which the vehicle moves to a parking space in a parking lot, predict a second route along which a pedestrian moves in the parking lot, and execute control for presenting, in the vehicle, a third route that replaces the first route when the first route intersects the second route.

In the first aspect, the control unit may predict, when a vehicle of the pedestrian is parked in the parking lot, the second route according to a position of the parking space at which the vehicle of the pedestrian is parked.

In the first aspect, the control unit may predict the second route by inputting position data indicating the position of the parking space at which the vehicle of the pedestrian is parked to a prediction model used for predicting a route and by acquiring a prediction result that is output from the prediction model.

In the first aspect, the control unit may generate or update the prediction model by associating data indicating movement histories of a plurality of pedestrians with data indicating positions of parking spaces at which vehicles of the plurality of pedestrians are parked and by executing machine learning.

In the first aspect, the control unit may predict, when the pedestrian moves to a destination outside the parking lot, the second route according to a kind of transportation used by the pedestrian for moving to the destination.

In the first aspect, the parking lot may have a plurality of points respectively associated with one or more kinds of transportation. The control unit may predict, as the second route, a route along which the pedestrian moves toward a point corresponding to the kind of transportation used by the pedestrian for moving to the destination from among the plurality of points.

In the first aspect, the control unit may predict the second route by inputting kind data indicating the kind of transportation used by the pedestrian for moving to the destination to the prediction model used for predicting the route and by acquiring the prediction result that is output from the prediction model.

In the first aspect, the control unit may generate or update the prediction model by associating the data indicating the movement histories of the plurality of pedestrians with data indicating the kinds of transportation used by the plurality of pedestrians and by executing machine learning.

In the first aspect, the control unit may predict the second route by inputting distribution data indicating distribution of vehicles parked in the parking lot to the prediction model used for predicting the route and by acquiring a prediction result that is output from the prediction model.

In the first aspect, the control unit may predict the second route further according to an attribute of the pedestrian.

In the first aspect, the control unit may predict the second route further according to a movement tendency of the pedestrian.

In the first aspect, the control unit may determine, as the third route, a route along which the vehicle bypasses the second route and moves to the same parking space as the parking space on the first route.

In the first aspect, the control unit may determine, as the third route, a route along which the vehicle moves to a parking space different from the parking space on the first route.

In the first aspect, the control unit may execute, when the first route intersects the second route and an increase in a cost due to changing from the first route to the third route does not exceed a threshold, the control for presenting, in the vehicle, the third route.

A system according to a second aspect of the present disclosure includes the control apparatus, and a terminal mounted on or connected to the vehicle, and configured to present the first route to a user who drives the vehicle.

A vehicle according to a third aspect of the present disclosure includes the control apparatus.

According to a fourth aspect of the present disclosure is a control method of executing control for presenting, in a vehicle, a first route along which the vehicle moves to a parking space in a parking lot. The control method includes predicting, by a control unit, a second route along which a pedestrian moves in the parking lot, and executing, by the control unit, control for presenting, in the vehicle, a third route that replaces the first route when the first route intersects the second route.

In the fourth aspect, the predicting may include predicting, when a vehicle of the pedestrian is parked in the parking lot, the second route according to a position of a parking space at which the vehicle of the pedestrian is parked.

In the fourth aspect, the predicting may include predicting, when the pedestrian moves to a destination outside the parking lot, the second route according to a kind of transportation used by the pedestrian for moving to the destination.

In the fourth aspect, the predicting may include predicting the second route by inputting distribution data indicating distribution of vehicles parked in the parking lot to a prediction model used for predicting a route and by acquiring a prediction result that is output from the prediction model.

With each aspect of the present disclosure, it is possible for a vehicle to smoothly move in a parking lot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to an embodiment of the present disclosure;

FIG. 2 is a diagram illustrating an example of a first route;

FIG. 3 is a diagram illustrating an example of a second route;

FIG. 4 is a diagram illustrating an example of a third route;

FIG. 5 is a block diagram illustrating a configuration of a control apparatus according to the embodiment of the present disclosure;

FIG. 6 is a block diagram illustrating a configuration of a terminal according to the embodiment of the present disclosure;

FIG. 7 is a flowchart illustrating an operation of the system according to the embodiment of the present disclosure; and

FIG. 8 is a flowchart illustrating an operation of the system according to a modified example of the embodiment of the present disclosure.

### DETAILED DESCRIPTION OF EMBODIMENTS

Hereinafter, several embodiments of the present disclosure will be described with reference to drawings.

In each drawing, same or corresponding parts are designated by same reference signs. In each embodiment, description thereof will be omitted or simplified as appropriate.

An embodiment of the present disclosure will be described.

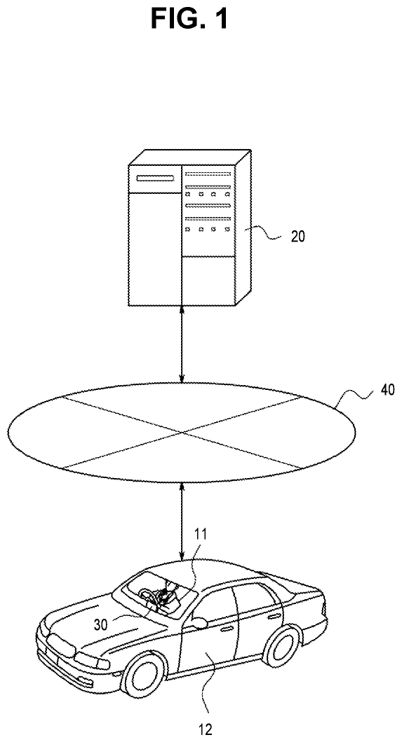

A configuration of a system 10 according to the present embodiment will be described with reference to FIG. 1.

The system 10 according to the present embodiment includes at least one control apparatus 20 and at least one terminal 30. The control apparatus 20 can communicate with the terminal 30 via a network 40.

The control apparatus 20 is installed in a facility, such as a data center. The control apparatus 20 may be a computer, such as a server belonging to a cloud computing system or other computing systems.

The terminal 30 is mounted on a vehicle 12 and used by a user 11 who drives the vehicle 12. The terminal 30 may be an in-vehicle device, such as a car navigation device. Alternatively, the terminal 30 may be connected to the vehicle 12 or held by the user 11 as an external device. Examples of the terminal 30 may include a mobile device, such as a mobile phone, a smartphone, or a tablet.

Examples of the vehicle 12 include any type of automobile, such as a gasoline vehicle, a diesel vehicle, a hybrid vehicle (HV), a plug-in hybrid vehicle (PHV), an electric vehicle (EV), or a fuel cell vehicle (FCV). In the present embodiment, the vehicle 12 is driven by a driver, but may be driven at any level of automation. The level of automation may be, for example, one of Level 1 to Level 5 classified by the Society of Automotive Engineers (SAE) leveling. The vehicle 12 may be a vehicle dedicated to Mobility-as-a-Service (MaaS).

The network 40 includes the Internet, at least one wide area network (WAN), at least one metropolitan area network (MAN), or a combination thereof. The network 40 may include at least one wireless network, at least one optical network, or a combination thereof. Examples of the wireless network include an ad-hoc network, a cellular network, a wireless local area network (LAN), a satellite communication network, or a terrestrial microwave network.

An overview of the present embodiment will be described with reference to FIGS. 1 to 4.

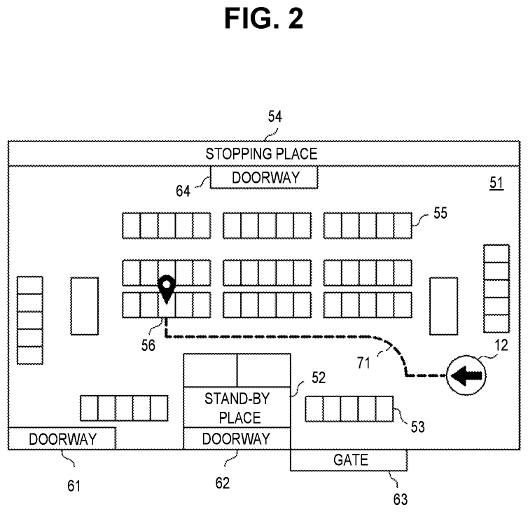

The control apparatus 20 executes control for presenting, in the vehicle 12, a first route 71 as illustrated in FIG. 2. The first route 71 is a route along which the vehicle 12 moves to a parking space 56 in a parking lot 51. In the present embodiment, the control for presenting, in the vehicle 12, the first route 71 means causing the terminal 30 to present the first route 71. In other words, in the present embodiment, the terminal 30 presents the first route 71 to the user 11.

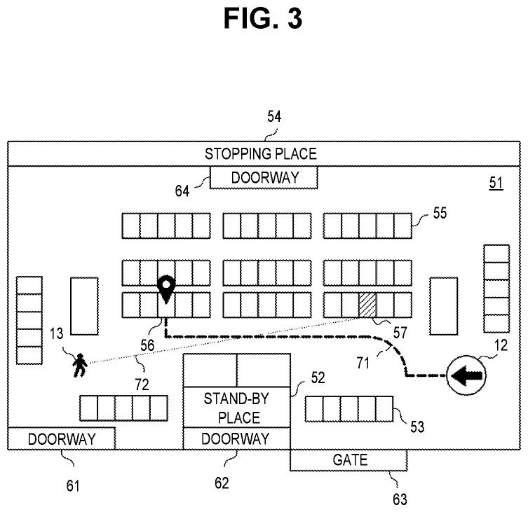

The control apparatus 20 predicts a second route 72 as illustrated in FIG. 3. The second route 72 is a route along which a pedestrian 13 moves in the parking lot 51.

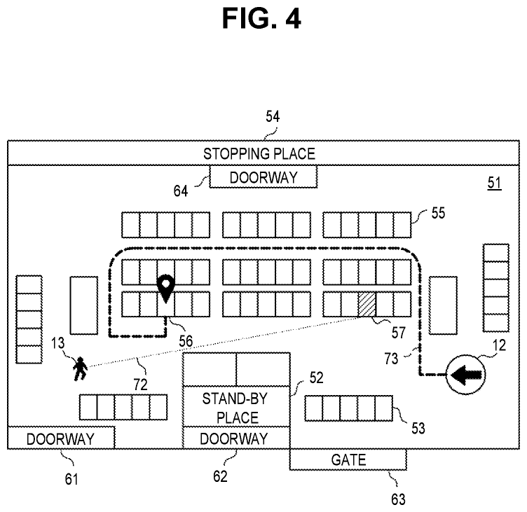

When the first route 71 intersects the second route 72, the control apparatus 20 executes control for presenting, in the vehicle 12, a third route 73 as illustrated in FIG. 4. The third route 73 is a route that replaces the first route 71. In the present embodiment, the control for presenting, in the vehicle 12, the third route 73 means causing the terminal 30 to present the third route 73. In other words, in the present embodiment, the terminal 30 presents the third route 73 to the user 11.

With the present embodiment, it is possible to adjust a movement route guided in the vehicle 12 according to a route along which the pedestrian 13 actually moves. For this reason, it is easy to avoid an occurrence of a vehicle stopping to wait for the pedestrian 13 to cross a road. As a result, the vehicle 12 can smoothly move in the parking lot 51. The safety in the parking lot 51 is also enhanced.

The parking lot 51 may be present at any position, but in the examples of FIGS. 2 to 4, it is present on the ground in a city. Each of the user 11 and the pedestrian 13 is a resident, a worker, or a visitor of the city.

Examples of the parking lot 51 include a flat parking lot, an underground parking lot, a multi-story car park, or any combination thereof. Various types of last mile mobility can be used for moving from the parking lot 51 to a group of buildings, such as houses or offices in the city. Last mile mobility includes an automated guided vehicle (AGV) or a delivery robot used for delivering luggage, a walking-area mobility, such as an electric kickboard or an electric scooter, a shared vehicle used for ride-sharing or car-sharing, a circulation bus or an on-demand bus used for transporting passengers, or any combination thereof. In the examples of FIGS. 2 to 4, it is possible to rent an AGV, a delivery robot, or a walking-area mobility at a stand-by place 52 in the parking lot 51. It is possible to board a shared vehicle in a dedicated parking space 53 in the parking lot 51. It is possible to stand by for a circulation bus at a stop 54 adjacent to the parking lot 51 or call an on-demand bus, and board the arriving circulation bus or on-demand bus.

The parking lot 51 has one or more entrances and one or more exits. In the examples of FIGS. 2 to 4, there is a first doorway 61, a second doorway 62, a gate 63, and a third doorway 64. The first doorway 61 is used by a person who walks from the parking lot 51 to a group of buildings in the city or from the group of buildings in the city to the parking lot 51. The second doorway 62 is a doorway closest to the stand-by place 52 and used by a person who moves using for a walking-area mobility from the parking lot 51 to the group of buildings in the city or from the group of buildings in the city to the parking lot 51. The second doorway 62 may also be used by a person who rents an AGV or a delivery robot. The gate 63 is a doorway arranged in front of the dedicated parking space 53 and used by a person who moves using a shared vehicle from the parking lot 51 to the group of buildings in the city or from the group of buildings in the city to the parking lot 51. The third doorway 64 is a doorway closest to the stop 54 and used by a person who moves using a circulation bus or an on-demand bus from the parking lot 51 to the group of buildings in the city or from the group of buildings in the city to the parking lot 51.

The parking lot 51 has a plurality of points respectively associated with one or more types of transportation. In the examples of FIGS. 2 to 4, the first doorway 61 is a point associated with “walking”. The stand-by place 52 is a point associated with a “walking-area mobility”. The stand-by place 52 may be further associated with an “AGV” or a “delivery robot”. Instead of the stand-by place 52, the second doorway 62 may be associated with an “AGV”, a “delivery robot”, or a “walking-area mobility”. The dedicated parking space 53 is a point associated with a “shared vehicle”. Instead of the dedicated parking space 53, the gate 63 may be associated with a “shared vehicle”. The third doorway 64 is a point associated with a “circulation bus” or an “on-demand bus”. Instead of the third doorway 64, the stop 54 may be associated with a “circulation bus” or an “on-demand bus”.

A sensor group used for observing the pedestrian 13 is installed in the parking lot 51. The sensor group includes one or more cameras, at least one light detection and ranging (LiDAR), or any combination thereof.

In the present embodiment, when a vehicle of the pedestrian 13 is parked in the parking lot 51, the control apparatus 20 predicts the second route 72 according to a position of a parking space 57 at which the vehicle of the pedestrian 13 is parked.

As a first example, it is assumed that a vehicle of a resident X who resides in a house B1 near the parking lot 51 is parked at the parking space 57. It is assumed that a position of the parking space 57 is registered in a database in association with the resident X. The position of the parking space 57 may be registered at, for example, a time of parking when the resident X is temporarily using the parking space 57, and at a time of reaching a contract when the resident X has a monthly contract. It is assumed that the resident X walks from the house B1 to the parking lot 51 and enters the parking lot 51 from the first doorway 61 to go shopping by car outside the city. In this case, the control apparatus 20 detects the resident X as the pedestrian 13 by analyzing an image obtained by the sensor group in the parking lot 51. The control apparatus 20 identifies the resident X using any method, such as face recognition. As illustrated in FIG. 3, the control apparatus 20 predicts, as the second route 72, a route from a current position of the resident X to the position of the parking space 57 registered in the database in association with the resident X.

In the present embodiment, when the pedestrian 13 moves to a destination outside the parking lot 51, the control apparatus 20 predicts the second route 72 according to a type of transportation used by the pedestrian 13 for moving to the destination.

As a second example, it is assumed that a worker Y working in an office B2 present far from the parking lot 51 arrives at the parking lot 51 by car from his home outside the city and parks at the parking space 57. It is assumed that a type of transportation used by the worker Y for moving to the office B2 is registered in the database in association with the worker Y. The type of transportation may be registered at, for example, a time of parking when the worker Y is temporarily using the parking space 57, and at the time of reaching a contract when the worker Y has a monthly contract. It is assumed that the worker Y exits the vehicle and starts walking in the parking lot 51. In this case, the control apparatus 20 detects the worker Y as the pedestrian 13 by analyzing an image obtained by the sensor group in the parking lot 51. The control apparatus 20 identifies the worker Y using any method, such as face recognition. The control apparatus 20 predicts, as the second route 72, a route from a current position of the worker Y to a position of a point corresponding to the type of transportation registered in the database in association with the worker Y. For example, when the type of transportation registered in the database in association with the worker Y is “walking”, the control apparatus 20 predicts, as the second route 72, the route from the current position of the worker Y to a position of the first doorway 61. Alternatively, when the type of transportation registered in the database in association with the worker Y is a “walking-area mobility”, the control apparatus 20 predicts, as the second route 72, a route from the current position of the worker Y to a position of the stand-by place 52. Alternatively, when the type of transportation registered in the database in association with the worker Y is a “shared vehicle”, the control apparatus 20 predicts, as the second route 72, a route from the current position of the worker Y to a position of the dedicated parking space 53. Alternatively, when the type of transportation registered in the database in association with the worker Y is a “circulation bus” or an “on-demand bus”, the control apparatus 20 predicts, as the second route 72, a route from the current position of the worker Y to the third doorway 64.

In the parking lot 51, a manually driven vehicle and an autonomous vehicle (AV) may coexist.

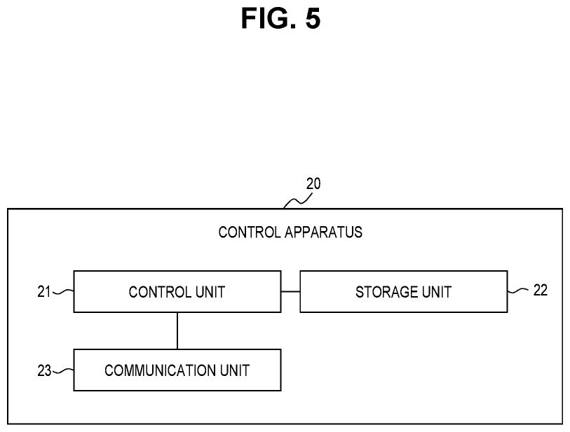

A configuration of the control apparatus 20 according to the present embodiment will be described with reference to FIG. 5.

The control apparatus 20 includes a control unit 21, a storage unit 22, and a communication unit 23.

The control unit 21 includes at least one processor, at least one programmable circuit, at least one dedicated circuit, or any combination thereof. The processor is a general-purpose processor, such as a central processing unit (CPU) or a graphics processing unit (GPU), or a dedicated processor specialized for a specific process. Examples of the programmable circuit include a field-programmable gate array (FPGA). Examples of the dedicated circuit include an application-specific integrated circuit (ASIC). The control unit 21 executes processing on an operation of the control apparatus 20 while controlling each unit of the control apparatus 20.

The storage unit 22 includes at least one semiconductor memory, at least one magnetic memory, at least one optical memory, or any combination thereof. Examples of the semiconductor memory include a random access memory (RAM) or a read-only memory (ROM). Examples of the RAM include a static random access memory (SRAM) or a dynamic random access memory (DRAM). Examples of the ROM include an electrically erasable programmable read-only memory (EEPROM). The storage unit 22 functions as, for example, a primary storage device, a secondary storage device, or a cache memory. The storage unit 22 stores data used for the operation of the control apparatus 20 and data obtained by the operation of the control apparatus 20.

The communication unit 23 includes at least one communication interface. Examples of the communication interface include a LAN interface. The communication unit 23 receives the data used for the operation of the control apparatus 20 and transmits the data obtained by the operation of the control apparatus 20.

A function of the control apparatus 20 is implemented by executing a control program according to the present embodiment by a processor as the control unit 21. In other words, the function of the control apparatus 20 is implemented by software. The control program causes a computer to function as the control apparatus 20 by causing the computer to execute the operation of the control apparatus 20. In other words, the computer functions as the control apparatus 20 by executing the operation of the control apparatus 20 according to the control program.

The program can be stored in a non-transitory computer-readable medium. Examples of the non-transitory computer-readable medium include a flash memory, a magnetic recording device, an optical disc, a photomagnetic recording medium, or a ROM. The program is distributed by, for example, selling, transferring, or renting a portable medium, such as a Secure Digital (SD) card, a digital versatile disc (DVD), or a compact disc read-only memory (CD-ROM) that stores the program. The program may be distributed by storing the program in a storage of a server and transferring the program from the server to another computer. The program may be provided as a program product.

For example, the computer temporarily stores a program stored in a portable medium or a program transferred from the server to a primary storage device. Then, the computer reads the program stored in the primary storage device by the processor, and executes the processing according to the read program by the processor. The computer may read the program directly from the portable medium and execute processing according to the program. The computer may sequentially execute the processing according to the received program each time the program is transferred from the server to the computer. The processing may be executed by a so-called application service provider (ASP) type service that implements a function only by an execution instruction and a result acquisition without transferring the program from the server to the computer. The program includes information used for processing by an electronic computer and equivalent to the program. For example, data that is not a direct command to a computer but has a property of defining the processing of the computer corresponds to “information equivalent to the program”.

A part or all of the functions of the control apparatus 20 may be implemented by a programmable circuit or a dedicated circuit as the control unit 21. In other words, a part or all of the functions of the control apparatus 20 may be implemented by hardware.

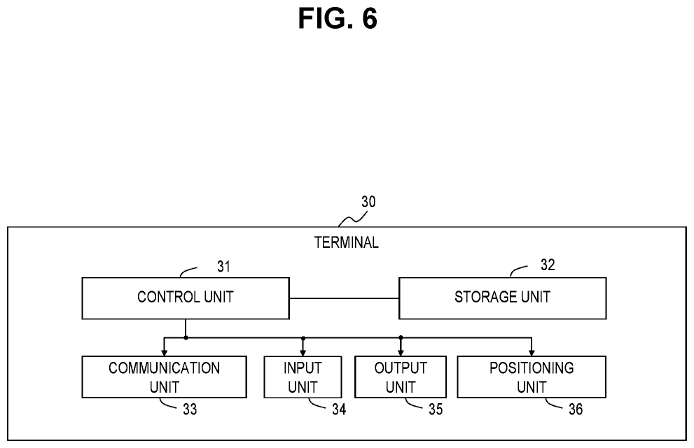

A configuration of the terminal 30 according to the present embodiment will be described with reference to FIG. 6.

The terminal 30 includes a control unit 31, a storage unit 32, a communication unit 33, an input unit 34, an output unit 35, and a positioning unit 36.

The control unit 31 includes at least one processor, at least one programmable circuit, at least one dedicated circuit, or any combination thereof. The processor is a general-purpose processor, such as a CPU or a GPU, or a dedicated processor specialized for a specific process. Examples of the programmable circuit include an FPGA. Examples of the dedicated circuit include an ASIC. The control unit 31 executes processing on an operation of the terminal 30 while controlling each unit of the terminal 30.

The storage unit 32 includes at least one semiconductor memory, at least one magnetic memory, at least one optical memory, or any combination thereof. Examples of the semiconductor memory include a RAM or a ROM. Examples of the RAM include an SRAM or a DRAM. Examples of the ROM include an EEPROM. The storage unit 32 functions as, for example, a primary storage device, a secondary storage device, or a cache memory. The storage unit 32 stores data used for the operation of the terminal 30 and data obtained by the operation of the terminal 30.

The communication unit 33 includes at least one communication interface. Examples of the communication interface include an interface corresponding to a mobile communication standard, such as LTE, Fourth standard, or Fifth standard, an interface corresponding to a near-field wireless communication standard, such as Bluetooth®, or a LAN interface. “LTE” is an abbreviation for Long-Term Evolution. “4G” is an abbreviation for Fourth Generation. “5G” is an abbreviation for Fifth Generation. The communication unit 33 receives the data used for the operation of the terminal 30 and transmits the data obtained by the operation of the terminal 30.

The input unit 34 includes at least one input interface. Examples of the input interface include a physical key, a capacitive key, a pointing device, a touch screen integrated with a display, a camera, LiDAR, or a microphone. The input unit 34 receives an operation of inputting the data used for the operation of the terminal 30. The input unit 34 may be connected to the terminal 30 as an external input device instead of being provided in the terminal 30. As a connection interface, for example, an interface corresponding to a standard, such as a USB, HDMI®, or Bluetooth®, can be used. “USB” is an abbreviation for Universal Serial Bus. “HDMI®” is an abbreviation for High-Definition Multimedia Interface.

The output unit 35 includes at least one input interface. Examples of the output interface include a display or a speaker. Examples of the display include a liquid crystal display (LCD) or an organic electroluminescence (EL) display. The output unit 35 outputs the data obtained by the operation of the terminal 30. The output unit 35 may be connected to the terminal 30 as an external output device instead of being provided in the terminal 30. As a connection interface, for example, an interface corresponding to a standard, such as a USB, HDMI®, or Bluetooth®, can be used.

The positioning unit 36 includes at least one global navigation satellite system (GNSS) receiver. Examples of the GNSS include the Global Positioning System (GPS), the Quasi-Zenith Satellite System (QZSS), BeiDou Navigation Satellite System (BDS), Global Navigation Satellite System (GLONASS), or Galileo. A QZSS satellite is called a Quasi-Zenith Satellite. The positioning unit 36 measures a position of the terminal 30.

A function of the terminal 30 is implemented by executing a terminal program according to the present embodiment by a processor as the control unit 31. In other words, the function of the terminal 30 is implemented by software. The terminal program causes the computer to function as the terminal 30 by causing the computer to execute the operation of the terminal 30. In other words, the computer functions as the terminal 30 by executing the operation of the terminal 30 according to the terminal program.

A part or all of the functions of the terminal 30 may be implemented by a programmable circuit or a dedicated circuit as the control unit 31. In other words, the part or all of the functions of the terminal 30 may be implemented by hardware.

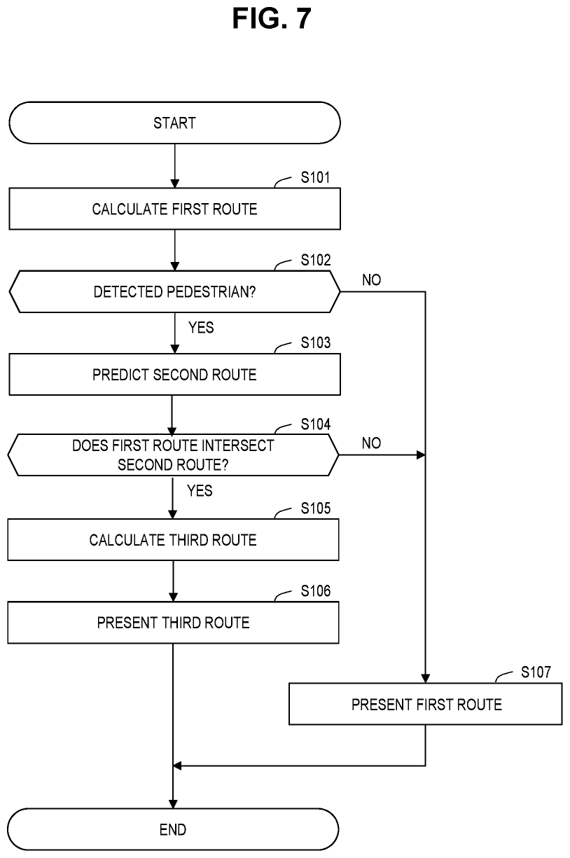

An operation of the system 10 according to the present embodiment will be described with reference to FIG. 7. The operation of the control apparatus 20 included in this operation corresponds to a control method according to the present embodiment.

In step S101, the control unit 21 of the control apparatus 20 calculates the first route 71. The first route 71 is a route along which the vehicle 12 moves to a parking space 56 in the parking lot 51. A process of step S101 may be executed in any procedures, but in the present embodiment, it is executed in the following procedures.

The positioning unit 36 of the terminal 30 measures the position of the terminal 30. The control unit 31 of the terminal 30 causes the communication unit 33 to transmit position data D1. The position data D1 is data indicating a position measured by the positioning unit 36 as the position of the vehicle 12. The communication unit 33 transmits the position data D1 to the control apparatus 20. The communication unit 23 of the control apparatus 20 receives the position data D1 from the terminal 30. The control unit 21 of the control apparatus 20 specifies the position of the vehicle 12 by acquiring the position data D1 received by the communication unit 23.

The control unit 21 of the control apparatus 20 analyzes a parking tendency of the user 11. The parking tendency may be analyzed using any method, but in the present embodiment, the parking tendency is analyzed by inputting, to a model that has learned data indicating a parking position when the user 11 has parked the vehicle 12 in the parking lot 51 in the past, whether the user 11 has followed a parking instruction, the number of occupants, presence/absence of charging equipment, or a parking method, such as forward parking or backward parking and by acquiring an analysis result from the learned model. Examples of the parking position include a vicinity of an entrance, a vicinity of an exit, a vicinity of stairs, a vicinity of an elevator, or the floor. Examples of the parking method include forward parking or backward parking. The control unit 21 selects one parking space 56 from among a plurality of parking spaces in the parking lot 51 according to the parking tendency of the user 11. In the examples of FIGS. 2 to 4, the parking space 56 from among empty parking spaces 55 in the parking lot 51 is determined to provide the highest degree of satisfaction to the user 11 by artificial intelligence (AI) based on the parking tendency of the user 11, and thus the parking space 56 is selected.

The control unit 21 of the control apparatus 20 calculates, as the first route 71, a route from the position of the specified vehicle 12 to a position of the selected parking space 56. As a method of calculating the route, an already-known method can be used. Machine learning, such as deep learning, may be used.

The parking space 56 may be manually selected by the user 11 instead of being automatically selected by the control apparatus 20.

In step S102, the control unit 21 of the control apparatus 20 detects the pedestrian 13. In the above-described first example, the control unit 21 detects the resident X as the pedestrian 13. In the second example, the control unit 21 detects the worker Y as the pedestrian 13. Then, a process of step S103 is executed. On the other hand, when the pedestrian 13 is not detected, a process of step S107 is executed.

In step S103, the control unit 21 of the control apparatus 20 predicts the second route 72. The second route 72 is a route along which a pedestrian 13 moves in the parking lot 51. The process of step S103 may be executed in any procedures, but in the present embodiment, it is executed in the following procedures.

When the vehicle of the pedestrian 13 is parked in the parking lot 51, the control unit 21 of the control apparatus 20 predicts the second route 72 according to the position of the parking space 57 at which the vehicle of the pedestrian 13 is parked. In the above-described first example, the control unit 21 predicts, as the second route 72, the route from the current position of the resident X to the position of the parking space 57 registered in the database in association with the resident X.

Specifically, the control unit 21 of the control apparatus 20 predicts the second route 72 by inputting position data D2 to a prediction model used for predicting a route and by acquiring a prediction result that is output from the prediction model. The position data D2 is data indicating the position of the parking space 57. Together with the position data D2, data indicating a position of the pedestrian 13 may be input to the prediction model. The position of the pedestrian 13 may be specified using any method. For example, the position of the pedestrian 13 may be specified by analyzing an image obtained by the sensor group in the parking lot 51. As a method of the image analysis, an already-known method can be used. Machine learning, such as deep learning, may be used.

The control unit 21 of the control apparatus 20 generates or updates the prediction model by associating data indicating movement histories of a plurality of pedestrians with data indicating positions of parking spaces at which vehicles of the plurality of pedestrians are parked and by executing machine learning. The movement histories of the plurality of pedestrians include a route along which each pedestrian has moved in the parking lot 51 in the past. For example, teacher data for machine learning can be created by associating, as a label, a route along which each pedestrian has moved in the parking lot 51 in the past with the position of a parking space at which a vehicle of each pedestrian is parked. Then, using this teacher data, a learned model as the prediction model can be generated by executing machine learning using an already-known algorithm.

When the pedestrian 13 moves to a destination outside the parking lot 51, the control unit 21 of the control apparatus 20 predicts, as the second route 72, a route along which the pedestrian 13 moves toward a point corresponding to a type of transportation used by the pedestrian 13 for moving to the destination from among the plurality of points of the parking lot 51. In the above-described second example, when the type of transportation registered in the database in association with the worker Y is “walking”, the control unit 21 predicts, as the second route 72, the route from the current position of the worker Y to the position of the first doorway 61. Alternatively, when the type of transportation registered in the database in association with the worker Y is a “walking-area mobility”, the control unit 21 predicts, as the second route 72, the route from the current position of the worker Y to the position of the stand-by place 52. Alternatively, when the type of transportation registered in the database in association with the worker Y is a “shared vehicle”, the control unit 21 predicts, as the second route 72, the route from the current position of the worker Y to the position of the dedicated parking space 53. Alternatively, when the type of transportation registered in the database in association with the worker Y is a “circulation bus” or an “on-demand bus”, the control unit 21 predicts, as the second route 72, the route from the current position of the worker Y to the third doorway 64.

Specifically, the control unit 21 of the control apparatus 20 predicts the second route 72 by inputting type data D3 to the prediction model used for predicting a route and by acquiring a prediction result that is output from the prediction model. The type data D3 is data indicating a type of transportation used by the pedestrian 13 for moving to a destination. Together with the type data D3, data indicating the position of the pedestrian 13 may be input to the prediction model. The position of the pedestrian 13 may be specified using any method. For example, the position of the pedestrian 13 is specified by analyzing an image obtained by the sensor group in the parking lot 51. As a method of the image analysis, an already-known method can be used. Machine learning, such as deep learning, may be used.

The control unit 21 of the control apparatus 20 generates or updates the prediction model by associating the data indicating movement histories of a plurality of pedestrians with data indicating types of transportation used by the plurality of pedestrians and by executing machine learning. The movement histories of the plurality of pedestrians include a route along which each pedestrian has moved in the parking lot 51 in the past. For example, teacher data for machine learning can be created by associating, as a label, a route along which each pedestrian has moved in the parking lot 51 in the past with a type of transportation used by each pedestrian. Then, using this teacher data, a learned model as the prediction model can be generated by executing machine learning using an already-known algorithm.

Regardless of whether the vehicle of the pedestrian 13 is parked in the parking lot 51 and whether the pedestrian 13 moves to a destination outside the parking lot 51, the control unit 21 of the control apparatus 20 may predict the second route 72 according to distribution of the vehicles parked in the parking lot 51.

Specifically, the control unit 21 of the control apparatus 20 may predict the second route 72 by inputting distribution data D4 to the prediction model used for predicting a route and by acquiring a prediction result that is output from the prediction model. The distribution data D4 is data indicating the distribution of the vehicles parked in the parking lot 51. As the distribution data D4, an image obtained by the sensor group in the parking lot 51 or an image processed into a format that is easily analyzed, such as a heat map, may be used.

The control unit 21 of the control apparatus 20 may predict the second route 72 further according to an attribute of the pedestrian 13. Examples of the attribute include a classification, a place of residence, a family structure, age, gender, a type of owned vehicle, a hobby, a taste, presence/absence of a handicap, or any combination thereof. Examples of the classification include a resident, a worker, or a visitor. The attribute of the pedestrian 13 may be specified using any method. For example, the attribute of the pedestrian 13 is specified by presenting a questionnaire used for specifying the attribute to the pedestrian 13 and analyzing answers for the presented questionnaire. As a method of an answer analysis, an already-known method can be used. Machine learning, such as deep learning, may be used.

The control unit 21 of the control apparatus 20 may predict the second route 72 further according to a movement tendency of the pedestrian 13. Examples of the movement tendency of the pedestrian 13 include speed at which the pedestrian 13 walks or whether the pedestrian 13 crosses a road diagonally. The movement tendency of the pedestrian 13 may be analyzed using any method. For example, the movement tendency of the pedestrian 13 is analyzed by inputting data indicating the movement history of the pedestrian 13 to the learned model and by acquiring an analysis result from the learned model. The movement history of the pedestrian 13 includes a route along which the pedestrian 13 has moved in the parking lot 51 in the past.

In step S104, the control unit 21 of the control apparatus 20 determines whether the first route 71 calculated in step S101 intersects the second route 72 predicted in step S103. As illustrated in FIG. 3, when the first route 71 intersects the second route 72, a process of step S105 is executed. On the other hand, when the first route 71 does not intersect the second route 72, the process of step S107 is executed.

In step S105, the control unit 21 of the control apparatus 20 calculates the third route 73. The third route 73 is a route that replaces the first route 71. The process of step S105 may be executed in any procedures, but in the present embodiment, it is executed in the following procedures.

The control unit 21 of the control apparatus 20 determines, as the third route 73, a route along which the vehicle 12 bypasses the second route 72 and moves to the same parking space 56 as that on the first route 71. In other words, as illustrated in FIG. 4, the control unit 21 calculates, as the third route 73, a route from the position of the vehicle 12 specified in step S101 to the position of the parking space 56 selected in step S101 without crossing the second route 72. As a method of calculating the route, an already-known method can be used. Machine learning, such as deep learning, may be used.

The parking space 56 may be changed to another parking space. In such a modified example, the control unit 21 of the control apparatus 20 determines, as the third route 73, a route along which the vehicle 12 moves to a parking space different from that on the first route 71. In other words, the control unit 21 calculates, as the third route 73, the route from the position of the vehicle 12 specified in step S101 to the position of a parking space different from the parking space 56 selected in step S101. For example, a parking space, which is determined to provide the highest degree of satisfaction to the user 11 by AI based on the parking tendency of the user 11, is selected as the “parking space different from the parking space 56” from among the empty parking spaces that can be reached from the position of the vehicle 12 without crossing the second route 72 in the parking lot 51.

In step S106, the control unit 21 of the control apparatus 20 executes the control for presenting, in the vehicle 12, the third route 73 calculated in step S105. This process may be executed in any procedures, but in the present embodiment, it is executed in the following procedures.

The control unit 21 of the control apparatus 20 generates guidance data D5. The guidance data D5 is data used for guiding the user 11 to the third route 73 calculated in step S105. The control unit 21 causes the communication unit 23 to transmit the generated guidance data D5. The communication unit 23 transmits the guidance data D5 to the terminal 30. The communication unit 33 of the terminal 30 receives the guidance data D5 from the control apparatus 20. The control unit 31 of the terminal 30 acquires the guidance data D5 received by the communication unit 33. The control unit 31 presents the acquired guidance data D5 to the user 11. As a method of presenting the guidance data D5 to the user 11, any method may be used, but in the present embodiment, a method of displaying the contents of the guidance data D5 on a display as the output unit 35 is used.

In step S107, the control unit 21 of the control apparatus 20 executes the control for presenting, in the vehicle 12, the first route 71 calculated in step S101. This process may be executed in any procedures, but in the present embodiment, it is executed in the following procedures.

The control unit 21 of the control apparatus 20 generates guidance data D6. The guidance data D6 is data used for guiding the user 11 to the first route 71 calculated in step S101. The control unit 21 causes the communication unit 23 to transmit the generated guidance data D6. The communication unit 23 transmits the guidance data D6 to the terminal 30. The communication unit 33 of the terminal 30 receives the guidance data D6 from the control apparatus 20. The control unit 31 of the terminal 30 acquires the guidance data D6 received by the communication unit 33. The control unit 31 presents the acquired guidance data D6 to the user 11. As a method of presenting the guidance data D6 to the user 11, any method may be used, but in the present embodiment, a method of displaying the contents of the guidance data D6 on the display as the output unit 35 is used.

As described above, in the present embodiment, the control unit 21 of the control apparatus 20 executes the control for presenting, in the vehicle 12, the first route 71 along which the vehicle 12 moves to the parking space 56 in the parking lot 51. The control unit 21 predicts the second route 72 along which the pedestrian 13 moves in the parking lot 51. When the first route 71 intersects the second route 72, the control unit 21 executes the control for presenting, in the vehicle 12, the third route 73 that replaces the first route 71.

With the present embodiment, it is possible to propose an alternative route when the route along which the vehicle 12 moves to the parking space 56 is predicted to intersect the route along which the pedestrian 13 moves. For this reason, it is easy to avoid an occurrence of a vehicle stopping to wait for the pedestrian 13 to cross a road. As a result, the vehicle 12 can smoothly move in the parking lot 51. The safety in the parking lot 51 is also enhanced.

As a modified example of the present embodiment, when the first route 71 intersects the second route 72 and an increase of a cost due to changing from the first route 71 to the third route 73 does not exceed a threshold, the control unit 21 of the control apparatus 20 may execute the control for presenting, in the vehicle 12, the third route 73.

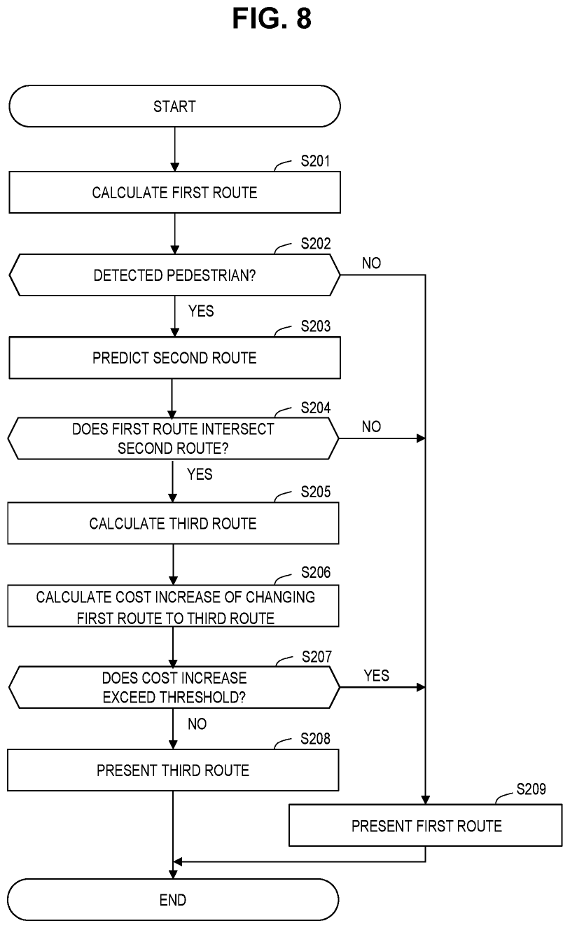

An operation of the system 10 according to this modified example will be described with reference to FIG. 8. The operation of the control apparatus 20 included in this operation corresponds to a control method according to this modified example.

Since the processes of steps S201 to S205 are the same as those of steps S101 to S105 illustrated in FIG. 7, description thereof will be omitted.

After step S205, in step S206, the control unit 21 of the control apparatus 20 calculates, as a first cost, a cost of the first route 71 calculated in step S201. The control unit 21 calculates, as a third cost, a cost of the third route 73 calculated in step S205. Then, the control unit 21 calculates, as a cost increase, a difference between the calculated first cost and the calculated third cost. As a cost calculation method, an already-known method can be used.

In step S207, the control unit 21 of the control apparatus 20 determines whether the cost increase calculated in step S206 exceeds the threshold. When the cost increase does not exceed the threshold, a process of step S208 is executed. On the other hand, when the cost increase exceeds the threshold, a process of step S209 is executed.

Since the processes of steps S208 and S209 are the same as those of steps S106 and S107 illustrated in FIG. 7, description thereof will be omitted.

The present disclosure is not limited to the embodiments described above. For example, two or more blocks described in the block diagram may be integrated, or one block may be divided. Instead of executing the two or more steps described in the flowchart in chronological order as described, they may be executed in parallel or in a different order, depending on the processing power of the device executing each step, or as needed. Other changes are possible without departing from the scope of the present disclosure.

For example, the control apparatus 20 may be provided in the vehicle 12. In that case, a part of the operation of the terminal 30 may be executed by the control apparatus 20. Instead of the terminal 30, the control apparatus 20 may present the first route 71 to the user 11. In other words, the control for presenting, in the vehicle 12, the first route 71 may mean directly presenting the first route 71 to the user 11. Similarly, instead of the terminal 30, the control apparatus 20 may present the third route 73 to the user 11. In other words, the control for presenting, in the vehicle 12, the third route 73 may mean directly presenting the third route 73 to the user 11. The terminal 30 may be integrated with the control apparatus 20.

What is claimed is:

1. A control apparatus comprising a control unit configured to:
execute control for presenting, in a vehicle, a first route along which the vehicle moves to a parking space in a parking lot;
predict a second route along which a pedestrian moves in the parking lot; and
execute control for presenting, in the vehicle, a third route that replaces the first route when the first route intersects the second route.

2. The control apparatus according to claim 1, wherein the control unit is configured to, when a vehicle of the pedestrian is parked in the parking lot, predict the second route according to a position of the parking space at which the vehicle of the pedestrian is parked.

3. The control apparatus according to claim 2, wherein the control unit is configured to predict the second route by inputting position data indicating the position of the parking space at which the vehicle of the pedestrian is parked to a prediction model used for predicting a route and by acquiring a prediction result that is output from the prediction model.

4. The control apparatus according to claim 3, wherein the control unit is configured to generate or update the prediction model by associating data indicating movement histories of a plurality of pedestrians with data indicating positions of parking spaces at which vehicles of the plurality of pedestrians are parked and by executing machine learning.

5. The control apparatus according to claim 1, wherein the control unit is configured to, when the pedestrian moves to a destination outside the parking lot, predict the second route according to a kind of transportation used by the pedestrian for moving to the destination.

6. The control apparatus according to claim 5, wherein:
the parking lot has a plurality of points respectively associated with one or more kinds of transportation; and
the control unit is configured to predict, as the second route, a route along which the pedestrian moves toward a point corresponding to the kind of transportation used by the pedestrian for moving to the destination from among the plurality of points.

7. The control apparatus according to claim 6, wherein the control unit is configured to predict the second route by inputting kind data indicating the kind of transportation used by the pedestrian for moving to the destination to a prediction model used for predicting a route and by acquiring a prediction result that is output from the prediction model.

8. The control apparatus according to claim 7, wherein the control unit is configured to generate or update the prediction model by associating the data indicating movement histories of a plurality of pedestrians with data indicating the kinds of transportation used by the plurality of pedestrians and by executing machine learning.

9. The control apparatus according to claim 1, wherein the control unit is configured to predict the second route by inputting distribution data indicating distribution of vehicles parked in the parking lot to a prediction model used for predicting a route and by acquiring a prediction result that is output from the prediction model.

10. The control apparatus according to claim 1, wherein the control unit is configured to predict the second route further according to an attribute of the pedestrian.

11. The control apparatus according to claim 1, wherein the control unit is configured to predict the second route further according to a movement tendency of the pedestrian.

12. The control apparatus according to claim 1, wherein the control unit is configured to determine, as the third route, a route along which the vehicle bypasses the second route and moves to the same parking space as the parking space on the first route.

13. The control apparatus according to claim 1, wherein the control unit is configured to determine, as the third route, a route along which the vehicle moves to a parking space different from the parking space on the first route.

14. The control apparatus according to claim 1, wherein the control unit is configured to, when the first route intersects the second route and an increase in a cost due to changing from the first route to the third route does not exceed a threshold, execute the control for presenting, in the vehicle, the third route.

15. A system comprising:
the control apparatus according to claim 1; and
a terminal mounted on or connected to the vehicle, and configured to present the first route to a user who drives the vehicle.

16. A vehicle comprising:
the control apparatus according to claim 1.

17. A control method of executing control for presenting, in a vehicle, a first route along which the vehicle moves to a parking space in a parking lot, the control method comprising:
predicting, by a control unit, a second route along which a pedestrian moves in the parking lot; and
executing, by the control unit, control for presenting, in the vehicle, a third route that replaces the first route when the first route intersects the second route.

18. The control method according to claim 17, wherein the predicting includes predicting, when a vehicle of the pedestrian is parked in the parking lot, the second route according to a position of a parking space at which the vehicle of the pedestrian is parked.

19. The control method according to claim 17, wherein the predicting includes predicting, when the pedestrian moves to a destination outside the parking lot, the second route according to a kind of transportation used by the pedestrian for moving to the destination.

20. The control method according to claim 17, wherein the predicting includes predicting the second route by inputting distribution data indicating distribution of vehicles parked in the parking lot to a prediction model used for predicting a route and by acquiring a prediction result that is output from the prediction model.
